(19) United States
(12) Patent Application Publication
(10) Pub. No.: US 2012/0324752 A1
(43) Pub. Date: Dec. 27, 2012

(54) BAG DRYING AND STORAGE DEVICE

(76) Inventor: WALLS JON, Orlando, FL (US)

(21) Appl. No.: 13/168,070

(22) Filed: Jun. 24, 2011

(51) Int. Cl. F26B 25/00

(52) U.S. Cl. 34/106

(57) ABSTRACT

A bag drying and storage device includes a base member and a plurality of arched upward protrusions secured thereto. A bag or similar item is placed on a pair of the protrusions and the arched shape allows air to circulate within each bag and decrease a drying time. Additionally, the protrusions can be independently rotated to adjust to the size of the bag secured thereon.

### BACKGROUND

### Field of the Invention

The present invention relates generally to drying devices, and more particularly to a device capable of accommodating and drying resalable plastic food storage bags and like articles.

The “Green Movement” of today has called for ideas that not only improve our day-to-day lives but also enhance the lives of generations to follow by sustainably managing the resources presently available. The introduction of the plastic food storage bag has greatly contributed to the overall convenience of storing food items by providing a way to store and transport items utilizing a disposable container, however, it has also played a major role in the dissolution of our environment. By providing an inexpensive plastic product that can be produced and thrown away by the thousands, plastic storage bags have become a major source of waste promulgating land fills across the globe. For this reason, there has been a growing movement to recycle these bags and, in turn, a need for a device that encourages and assists in the re-use of food storage bags via a practical and environmentally conscious design.

There have been previous devices directed towards the storage and drying of plastic bags that generally include multiple straight upward protrusions for holding a bag in a vertical manner. However these designs have an inherent disadvantage of allowing the bags to remain substantially closed when installed on the device and the sides of the bags remain in contact with each other when wet, thus preventing adequate airflow and greatly increasing the time necessary to dry the inside of each bag. Moreover, these are often manufactured from environmentally non-friendly materials which make them unattractive to their intended market audience.

Accordingly, it would be beneficial to provide a bag drying device that is ecologically friendly, is simple to use, is inexpensive to manufacture, and that overcomes the deficiencies described above.

### SUMMARY OF THE INVENTION

It is an object of the invention to provide a bag drying device for quickly storing and drying plastic bags in an environmentally friendly manner.

It is another object of the invention to provide a bag drying device that can be adjusted to fit a particular length and width of a plastic bag.

Accordingly, there is provided a bag drying device having a generally planar base member and a plurality of upward protrusions secured thereto. Each of the protrusions can preferably include a curved shape for ensuring a bag remains open and increasing the airflow to the inside of the bag.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of the bag drying device that is useful for understanding the inventive concepts disclosed herein.

FIG. 2 is top view of the bag drying device in accordance with one embodiment of the present invention

FIG. 3 is a bottom view of the bag drying device in accordance with one embodiment of the present invention

FIG. 4 is a front view of the bag drying device in operation, in accordance with one embodiment of the present invention.

FIG. 5 is a perspective view of the bag drying device in operation, in accordance with one embodiment of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

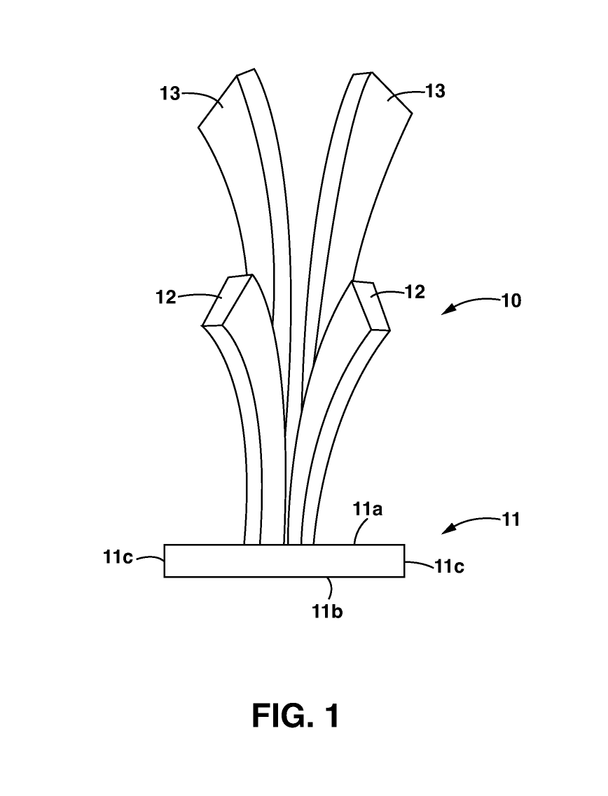

For purposes of this description, the terms “upper,” “bottom,” “right,” “left,” “front,” “vertical,” “horizontal,” and derivatives thereof shall relate to the invention as oriented in FIG. 1.

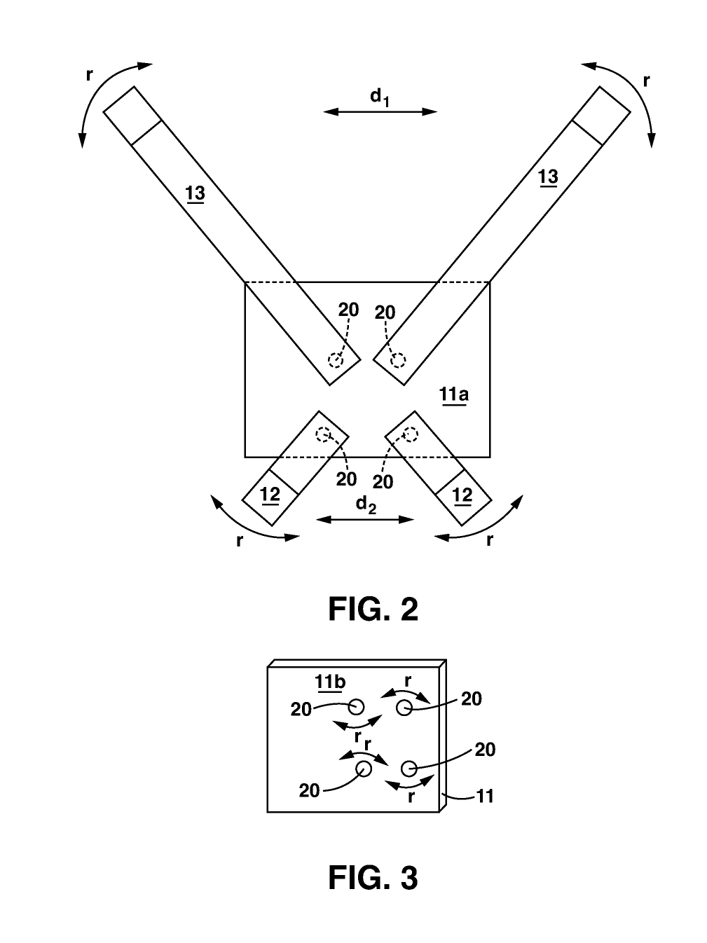

FIGS. 1-3 illustrate one embodiment of a bag drying and storage device 10 that is useful for understanding the inventive concepts disclosed herein. As shown, the device 10 can include a base member 11, having two anterior support rods 12, and two posterior support rods 13 positioned thereon.

The base member 11 can act to position each of the support rods 12 and 13 in a vertical orientation to facilitate drying of plastic bags and like items. In one embodiment the base member 11 can include a generally rectangular platform having a planar top surface 11a, a planar bottom surface 11b and a plurality of opposing side surfaces 11c. In one preferred embodiment, the base member can be constructed from recycled material such as wood or pulp having excellent durability, environmental attributes and the ability to absorb water droplets emanating from the plastic bags when the device is in use. Of course, other materials such as non-recycled wood, composite materials and the like are also contemplated.

Both the anterior support rods 12 and the posterior support rods 13 can act to position bags of varying sizes on the device 10 for storage and/or drying. To this end, in one embodiment, the posterior support rods 13 can be taller than the anterior support rods 12 in order to allow the device to accommodate bags of varying lengths 14a. As shown, each of the support rods 12 and 13 can include an elongated vertical shaft having a generally arched shape radiating outward in a horizontal manner from the base member 11. Moreover, it is preferred that each of the support rods 12 and 13 be constructed from recycled material such as wood or pulp having excellent durability, environmental attributes and the ability to absorb water droplets emanating from the plastic bags when the device is in use. Of course, other materials such as non-recycled wood, composite materials and the like are also contemplated.

In one preferred embodiment, each of the support rods 12 and 13 can be secured to the base member 11 via conventional hardware 20 such as screws, dowels or other known devices capable of allowing each support rod to individually pivot (see arrow r) in a horizontal manner, while remaining secured to the base member 11. As shown in FIG. 3, the hardware 20, according to one embodiment can be secured through the bottom end of the base member 11b until making contact with the bottom of each support rod. As will be described below, by allowing each support rod to pivot in place, thereby increasing distance d1 and d2, in order to allow the device 10 to securely position bags of varying widths 14b.

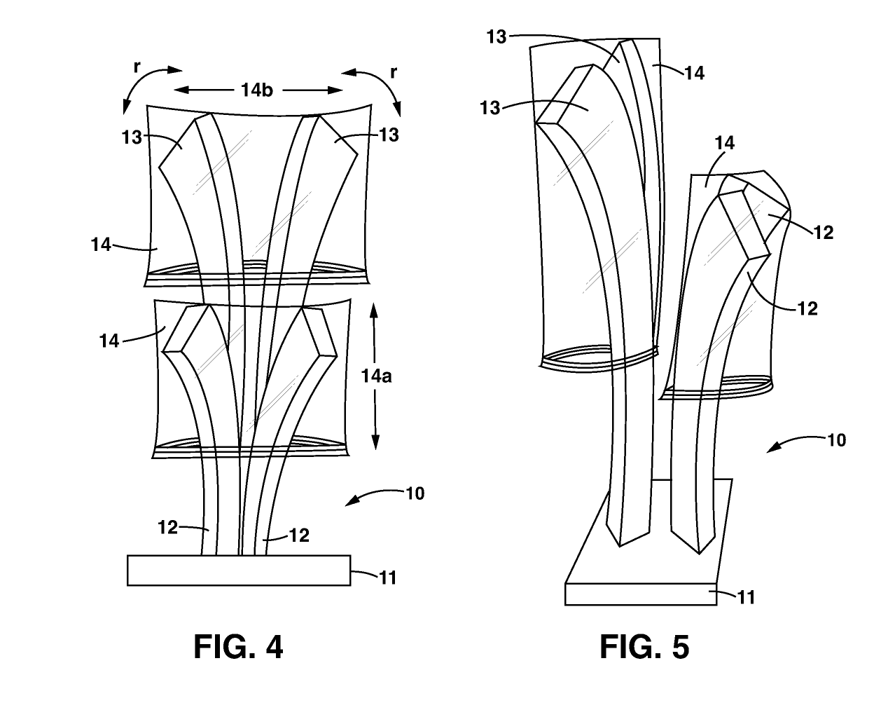

FIGS. 4 and 5 illustrate one embodiment of the bag drying device 10 in operation. As shown, a plastic food storage bag 14 can be placed over each of the anterior 12 and posterior support rods 13, respectively. To this end, each bag 14 can be opened, inverted, and placed over the corresponding support rods 12 or 13 such that the pair of support rods 12 or 13 are located inside the bag 14 itself. Additionally, once positioned inside the bag, each support rod 12 or 13 (depending on whether the bag is on the anterior support rods or the posterior support rods, respectively) can be rotated (see arrow r) until reaching the maximum width of the corresponding bag 14b.

Moreover, and as best illustrated in FIG. 5, the arched shape of the support rods 12 and 13 act to ensure that each bag 14 remains in a fully open position when secured to device 10. To this end, the bag sides are prevented from making contact with each other thus increasing airflow to the bag and decreasing the time necessary for each bag to dry.

Although described above as utilizing rotating support arms 12 and 13 other embodiments are also contemplated. For example, each of the support rods 12 and 13 can be affixed to the base member 11 in a non-rotatable manner (via glue for example) and at any number of angles in order to reduce construction costs while providing an effective bag drying device as described above.

As described herein, one or more elements of the bag drying device 10 can be secured together utilizing any number of known attachment means such as, for example, screws, glue and compression fittings, among others. Moreover, although the above embodiments have been described as including separate individual elements, the inventive concepts disclosed herein are not so limiting. To this end, one of skill in the art will recognize that one or more individual elements such as the base member 11, the anterior rods 12, and/or the posterior rods 13, for example, may be formed together as one continuous element, either through manufacturing processes, such as casting, or molding, or through the use of a singular piece of material (such as wood, for example) milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A bag drying and storage device comprising:
a plurality of rotatable elongated shafts having a bottom end and a top end, each of said elongated shafts being configured to position a bag in an inverted state;
a base member having a top surface and a bottom surface, said base member being configured to position each of the plurality of elongated shafts in a vertical orientation;
one or more connectors configured to secure the bottom end of each support shaft to the top surface of the base member in a rotatable manner,
wherein each of said support rods includes an arched shape radiating outward in a horizontal manner from the base member, said arched shape being configured to position a bag in an opened state.

2. The bag drying device of claim 1, wherein said plurality of elongated shafts consists of two posterior shafts having a first length and two anterior shafts having a second length.

3. The bag drying device of claim 2, wherein said posterior shafts are configured to independently rotate in order to match a width of a first bag.

4. The bag drying device of claim 2, wherein said anterior shafts are configured to independently rotate in order to match a width of a second bag.

5. The bag drying device of claim 2, wherein said first length is greater than said second length.

6. The bag drying device of claim 2, wherein said first length is less than said second length.

7. The bag drying device of claim 1, wherein said connectors includes at least one of a screw or dowel.

8. The bag drying device of claim 1, wherein the base member is configured to absorb a moisture emanating from a bag positioned on the device.

9. The bag drying device of claim 1, wherein each of said base member and support rods are constructed from recycled wood material.

10. A bag drying device comprising:
a plurality of elongated shafts having a bottom end and a top end, each of said elongated shafts being configured to position a bag in an inverted state;
a base member having a top surface and a bottom surface, said base member being configured to position each of the plurality of elongated shafts in a vertical orientation;
one or more connectors configured to secure the bottom end of each support shaft to the top surface of the base member,
wherein each of said support rods includes an arched shape radiating outward in a horizontal manner from the base member.

11. The bag drying device of claim 10, wherein said plurality of elongated shafts consists of two posterior shafts having a first length and two anterior shafts having a second length.

12. The bag drying device of claim 11, wherein said first length is greater than said second length.

13. The bag drying device of claim 11, wherein said first length is less than said second length.

14. The bag drying device of claim 10, wherein said connectors includes at least one of a screw or dowel.

15. The bag drying device of claim 10, wherein the base member is configured to absorb a moisture emanating from a bag positioned on the device.

16. The bag drying device of claim 10, wherein each of said base member and support rods are constructed from recycled wood material.
